(19) United States
(12) Patent Application Publication
(10) Pub. No.: US 2024/0247136 A1
(43) Pub. Date: Jul. 25, 2024

(54) RUBBER COMPOSITION CONTAINING ADDITIVE AND USE THEREOF

(71) Applicant: SCHILL + SEILACHER STRUKTOL GMBH, Hamburg (DE)

(72) Inventors: Volker BÖRGER, Hamburg (DE); Christian GEIDEL, Hamburg (DE)

(21) Appl. No.: 18/566,401

(22) PCT Filed: Jun. 3, 2022
(86) PCT No.: PCT/EP2022/065214

§ 371 Date: Dec. 1, 2023

(30) Foreign Application Priority Data
Jun. 4, 2021 (EP) 21177722.2

(51) Int. Cl. C08L 9/06; B60C 1/00

(52) U.S. Cl. CPC C08L 9/06; B60C 1/0016; B60C 2200/04

(57) ABSTRACT

The present invention relates to a rubber composition containing rubber and at least one rubber additive based on a higher molecular weight colophony rosin ester. The at least one rubber additive comprises colophony rosin ester made from colophony rosin and at least one alcohol, wherein the colophony rosin used for producing the colophony rosin ester has an acid number of 130 to 190 mg KOH/g and the at least one employed alcohol has not more than seven hydroxyl groups and a molecular weight of at least 200 g/mol. The present invention further relates to the use of the rubber additive in a rubber composition, to a tire, where at least one component part is at least partially produced from the rubber composition according to the invention, and to processes for the production thereof.

### FIELD OF THE INVENTION

The present invention relates to a rubber composition which contains rubber and at least one rubber additive based on a higher-molecular-weight rosin ester. The present invention furthermore relates to the use of the rubber additive in a rubber composition, to a tyre in which at least one component part is produced at least partially from the rubber composition according to the invention, and to processes for the production thereof.

### BACKGROUND OF THE INVENTION

Vehicle tyres must meet various road traffic requirements. The compound formulation of the tread is usually optimized for the specific requirements of a tyre in its respective area of use. During the development of tread compounds for Ultra High Performance (UHP) and summer tyres it has been attempted in recent years to achieve improvements in properties such as tyre grip, tyre wear and tyre handling. For this purpose, a high proportion of resin, e.g. based on alpha-methylstyrene, terpene and coumarone-indene resins, was added to the rubber compositions used for tyre production for passenger motor vehicles.

However, the above approach results in a poorer processability of the rubber composition, in particular the problems of tackiness, high viscosity and lack of green strength arise. To eliminate or reduce these problems, a number of processing aids (additives) are used in the rubber/vulcanized rubber industry, but the use thereof often leads to disadvantages in the case of other desired properties, such as e.g. a lower stiffness of the rubber compound or the vulcanized rubber compound produced therefrom for the tyre. This means higher tyre wear and poorer tyre handling. Poor tyre wear properties are problematic due to the material released thereby (fine particulate matter problem). Wet grip properties of the tyre play an important role in safety and the rolling resistance behaviour plays an important role in energy consumption.

It is known among experts that an improvement in a physical property of a rubber composition is associated with the impairment of another. In a tread compound there is a so-called trade-off between the processability of the rubber composition on the one hand and at least one of the properties of wet braking behaviour, rolling resistance and tyre wear on the other. Such a compromise between good processing properties and disadvantages in the performance criteria such as tyre grip (wet and dry grip, tyre wear and tyre handling) is being accepted less and less today.

WO 2016/105909 A1 relates to rubber compositions which comprise rubber, silica, organosilane that contains at least one cyclic and/or bridged alkoxy group, and “rosin-containing material”. The rubber compositions described can be used for the production of tyres. The rubber compositions can comprise rosin ester. WO '909 does not disclose the use of rosin ester with a high molecular weight.

WO 2017/117578 A1 relates to a process for the preparation of a shaped rubber composition, wherein a rubber compound is combined with an extender compound. The rubber compositions described can be used for the production of tyres. The extender compound can be a rosin ester, wherein, among other things, ethylene glycol, diethylene glycol or triethylene glycol can be used as alcohol.

WO 2011/130525 A1 relates to a tyre rubber composition which comprises a rubber compound and a processing oil, wherein the processing oil in turn comprises a modified tall oil pitch, and to tyres produced therefrom (see abstract). Tall oil (also known as liquid colophony) is an oily mixture of substances which results as a by-product during the production of wood pulp. Tall oil pitch typically contains 2-8 wt.-% fatty acids, 3 to 15 wt.-% resin acids and 30 to 45 wt.-% “unsaponifiable matter”. The acid number of tall oil pitch lies between 15 and 50.

An object of the present invention is to develop a new additive for Ultra High Performance (UHP) and summer tyres, which improves the processing properties of the rubber composition which is used for the production of these tyres. At the same time, the other performance properties of the tyres, in particular the handling behaviour, the properties with respect to wet and dry braking, the tyre wear and the rolling resistance behaviour, are not to be impaired or are even to be at least partially improved as well.

### SUMMARY OF THE INVENTION

The object is achieved according to the invention by a rubber composition which contains rubber and at least one rubber additive, characterized in that the at least one rubber additive comprises rosin ester from rosin and at least one alcohol, wherein the rosin used to prepare the rosin ester has an acid number of from 130 to 190 mg KOH/g and the alcohol(s) used has or have not more than seven hydroxyl groups and a molecular weight of at least 200 g/mol.

A further aspect of the present invention relates to the use of rosin ester from rosin and at least one alcohol as rubber additive in a rubber composition for improving the Mooney viscosity of the rubber composition and/or for improving at least one of wear, grip and rolling resistance of a tyre produced from the rubber composition, wherein the rosin used has an acid number of from 130 to 190 mg KOH/g and the alcohol(s) used has or have a molecular weight of at least 200 g/mol and not more than seven hydroxyl groups.

A further aspect of the present invention relates to a process for producing a tyre, characterized in that one or more component parts of the tyre are produced from a rubber composition of the present invention and the rubber composition is cured.

A further aspect of the present invention relates to a tyre in which at least one component part has been produced at least partially from the rubber composition according to the invention, and the tyre is preferably an Ultra High Performance (UHP) or summer tyre.

Preferred embodiments of the invention are the subject-matter of the dependent claims. Embodiments of the invention comprise the constituents listed in the following and can in particular consist of them.

### BRIEF DESCRIPTION OF THE FIGURES

FIG. 1 shows three different extrudates which have been produced from the rubber compositions J, K and L, as described in Example 7.

### DETAILED DESCRIPTION OF THE INVENTION

The inventors have surprisingly found that rosin esters which have an alcohol component (by this is meant the moiety derived from the corresponding alcohol) with a high molecular weight have positive properties in a rubber composition, compared with rosin esters having an alcohol component with a low molecular weight.

### Rubber Composition

The constituents of the rubber composition according to the invention are described in more detail in the following. All statements also apply to the tyre according to the invention, in which at least one component part at least partially consists of the rubber composition according to the invention, and to the use according to the invention of rosin ester.

The specification phr (parts per hundred parts of rubber by weight) used in this document is the quantity specification usual in the rubber industry for compound formulations. The proportioning of the parts by weight of the individual substances in this document is based on 100 parts by weight of the total mass of all high-molecular-weight and consequently solid rubbers present in the compound.

### Rosin Ester

Rosin (colophony) is a resinous material which is obtained from many plants, in particular from conifers such as Pinus Sylvestris, Pinus palustris and Pinus caribaea. Rosin consists of a mixture of rosin acids and further components in small quantities. The rosin acids include for example abietic acid, neoabietic acid, dehydroabietic acid, pimaric acid, levopimaric acid, sandaracopimaric acid, isopimaric acid and palustric acid. The type and relative quantities of the resin acids present in the rosin depend in part on the plant type and the production process and can vary.

In a preferred embodiment, a disproportionated rosin is used. Disproportionated rosin principally contains dehydrogenated rosin acids and hydrogenated rosin acids. It is produced from gum rosin by heating or acid treatment. The rosin which is used to prepare the rosin ester of the present invention preferably contains less than 5 wt.-% abietic acid and/or more than 30 wt.-% dehydroabietic acid.

The rosin which is used to prepare the rosin ester has an acid number of from 130 to 190 mg KOH/g, preferably from 140 to 180 mg KOH/g and in particular 150 to 170 mg KOH/g. The measurement of the acid number is effected by means of DIN EN ISO 2114.

Furthermore, the rosin which is used to prepare the rosin ester preferably has a softening point (ring and ball), measured by means of ASTM E 28, of between 50 and 100° C., preferably between 60 and 90° C., between 65 and 80° C. and in particular between 68 and 74° C.

The term “rosin ester” refers to the ester of a rosin as acid component with at least one alcohol. Rosin esters can be prepared from rosin and alcohol by processes known to a person skilled in the art. Mixtures of rosins which can originate from different sources can also be used.

The rosin ester is prepared by esterifying the rosin with at least one alcohol having a molecular weight of at least 200 g/mol. The at least one alcohol preferably has a molecular weight of at least 300 g/mol, such as 380 g/mol, in particular of at least 400 g/mol. The alcohol can have a molecular weight of from 200 to 2000 g/mol, preferably 300 to 2000 g/mol, such as 400 g/mol to 2000 g/mol or 400 g/mol to 1500 g/mol.

It is known to experts that particular alcohols can be prepared in a molecularly uniform manner, whereas alcohols which are prepared by polymerization are polymolecular, i.e. consist of distributions of macromolecules having different molar masses. In the context of the present invention, reference is made to the average molecular weight (number average) in the case of polymolecular alcohols. Methods for the determination thereof are known to experts, such as for example DIN 53240 or in particular ASTM D4274-16.

The at least one alcohol used to prepare the rosin ester has not more than seven hydroxyl groups.

In a preferred embodiment, the alcohol used to prepare the rosin ester has from 2 to 7 hydroxyl groups.

In a preferred embodiment, an alcohol having not more than 6 hydroxyl groups, preferably not more than 4 hydroxyl groups, is used in the preparation of the rosin ester. In a particularly preferred embodiment, the alcohol used to prepare the rosin ester has 2 or 3 hydroxyl groups.

Preferably, the at least one alcohol used for the rosin ester has at least 7 carbon atoms, preferably at least 8, in particular at least 15 carbon atoms.

In a preferred embodiment, the alcohol used has no aromatic groups.

In a further preferred embodiment, the alcohol used furthermore consists only of carbon, hydrogen and oxygen.

The at least one alcohol used to prepare the rosin ester can be straight-chain or branched, in particular straight-chain, and can optionally be interrupted by a heteroatom.

In an embodiment, only one alcohol (however this includes those higher-molecular-weight alcohols which have a certain molecular weight distribution, such as PEG 400) is used to prepare the rosin ester. In a further embodiment, at least two different alcohols, e.g. two different alcohols which then in each case have not more than seven hydroxyl groups and a molecular weight of at least 200 g/mol, are used to prepare the rosin ester.

In a preferred embodiment, the at least one alcohol used to prepare the rosin ester has a molecular weight of at least 300 g/mol and not more than six hydroxyl groups.

In a further preferred embodiment, the at least one alcohol used to prepare the rosin ester has a molecular weight of at least 300 g/mol and not more than four hydroxyl groups.

In a further preferred embodiment, the at least one alcohol used to prepare the rosin ester has a molecular weight of at least 380 g/mol and not more than four hydroxyl groups.

In a further preferred embodiment, rosin having an acid number of from 140 to 180 mg KOH/g and at least one alcohol having a molecular weight of at least 380 g/mol is used in the preparation of the rosin ester.

In a further preferred embodiment, rosin having an acid number of from 140 to 180 mg KOH/g and at least one alcohol having a molecular weight of at least 380 g/mol and 2 or 3 hydroxyl groups is used in the preparation of the rosin ester.

In a further preferred embodiment, rosin having an acid number of from 150 to 170 mg KOH/g and at least one alcohol having a molecular weight of from 400 g/mol to 1500 g/mol is used in the preparation of the rosin ester.

In a further preferred embodiment, the at least one alcohol used to prepare the rosin ester has a molecular weight of at least 200 g/mol, 2 or 3 hydroxyl groups and at least 7 carbon atoms.

In a further particularly preferred embodiment, the at least one alcohol used to prepare the rosin ester has a molecular weight of at least 380 g/mol and two or three hydroxyl groups.

According to a preferred embodiment, the at least one alcohol used is selected from the group consisting of polyethylene glycol, as defined in more detail below, ethoxylated glycerol, as defined in more detail below, ethoxylated trimethylolpropane, ethoxylated pentaerythritol or ethoxylated sorbitol.

The at least one alcohol used to prepare the rosin ester can be selected from the group consisting of C₂ to C₄ alkoxylate of a polyol, polyethylene glycol (PEG), polypropylene glycol (PPG) and/or copolymer of ethylene oxide and propylene oxide.

In an embodiment, the rosin ester is prepared from rosin and at least one polyether such as polyethylene glycol (PEG), polypropylene glycol (PPG) and/or copolymer of ethylene oxide and propylene oxide. The copolymers of ethylene oxide and propylene oxide can be statistical copolymers or block copolymers. It is known to a person skilled in the art that polyethers having higher molar masses are polymolecular, i.e. consist of distributions of macromolecules having different molar masses. According to the invention, polyethylene glycols, polypropylene glycols and/or copolymers of ethylene oxide and propylene oxide having an average molecular weight in the range of from approximately 200 to 1500 g/mol can be used, e.g. 200 to 800 g/mol can be used to prepare the rosin ester.

In a preferred embodiment, the at least one alcohol used is a polyethylene glycol, preferably a polyethylene glycol having a molecular weight of from 200 to 800 g/mol.

In a further preferred embodiment, the at least one alcohol used is a polypropylene glycol, preferably a polypropylene glycol having a molecular weight of from 200 to 800 g/mol.

In a further preferred embodiment, the rosin ester is prepared from at least one statistical copolymer of ethylene oxide and propylene oxide, preferably with a copolymer having a molecular weight of from 200 to 800 g/mol. In a preferred embodiment, the statistical copolymer of ethylene oxide and propylene oxide has an ethylene oxide group content of from 10 to 30 wt.-%.

In a further embodiment, the rosin ester is prepared from at least one block copolymer of ethylene oxide and propylene oxide having a molecular weight of from 50 to 4500 g/mol, such as 200 to 3000 and in particular 500 to 2500 g/mol. According to a preferred embodiment, the ethylene oxide/propylene oxide block copolymer has an ethylene oxide group content of from 10 to 80 wt.-%, such as 10 to 55 wt.-%. The block copolymers can be constructed with polypropylene glycol molecules being located in the middle and polyoxyethylene groups being located at both ends.

The ethylene oxide/propylene oxide block copolymers to be used according to the invention are compounds customary in the trade. They can be prepared by reacting polypropylene glycol with ethylene oxide. Examples of ethylene oxide/propylene oxide block copolymers are the Pluronic PE polymers from BASF SE, such as Pluronic PE 3100, Pluronic PE 3500, Pluronic PE 4300, Pluronic PE 6100, Pluronic PE 6120, Pluronic PE 6200, Pluronic PE 6400, Pluronic PE 6800, Pluronic PE 8100, Pluronic PE 9200, Pluronic PE 9400, Pluronic PE 10100, Pluronic PE 10300, Pluronic PE 10400 and Pluronic PE 10500.

In a further embodiment, the rosin ester is prepared from at least one C₂ to C₄ alkoxylate of a polyol. By polyols is meant those substances which have at least two free hydroxyl groups. The hydrocarbon moiety of the polyol is a group which contains carbon and hydrogen, wherein at least two carbon atoms are bound to one hydroxyl group. It can be straight-chain or branched, in particular straight-chain, and can optionally be interrupted by a heteroatom.

A C₂ to C₄ alkoxylate of a polyol is a polyol which has been reacted with a C₂ to C₄ alkylene oxide, wherein several reactions can take place one after another on a hydroxyl group of the polyol. Examples of C₂ to C₄ alkylene oxides are ethylene oxide, propylene oxide and 1-butene oxide. The reaction of the polyols with the C₂ to C₄ alkylene oxide is effected using established processes.

Mixed C₂ to C₄ alkoxylates can also be used, in which a polyol is reacted using a mixture of C₂ to C₄ alkylene oxides (mixture of ethylene oxide and propylene oxide and/or 1-butylene oxide).

In a preferred embodiment, the rosin ester is prepared from at least one polyol alkoxylate with up to 10, such as 5 to 10, e.g. 7, alkylene oxide units.

The C₂ to C₄ alkoxylate of a polyol can have an average molecular weight in the range of from approximately 200 to 1500 g/mol, such as approximately 200 to 800 g/mol, in particular 300 to 500 g/mol.

In an embodiment, the C₂ to C₄ alkoxylate has at least 2 hydroxyl groups. In a preferred embodiment, the C₂ to C₄ alkoxylate of a polyol used to prepare the rosin ester has between 2 and 4 hydroxyl groups, such as 2 or 3 hydroxyl groups.

In a preferred embodiment, the rosin ester is prepared from at least one polyol ethoxylate with up to 10, such as 5 to 10, e.g. 7, ethylene oxide units (EO units).

In a further preferred embodiment, the rosin ester is prepared from at least one polyol propoxylate with up to 10, such as 5 to 10, e.g. 7, propylene oxide units (PO units).

The polyol ethoxylate or polyol propoxylate preferably has between 2 and 6, such as between 2 and 4 hydroxyl groups.

The polyol of the C₂ to C₄ alkoxylate can be a C₂ to C₁₅ polyol. This means that the polyol has from 2 to 15 carbon atoms. C₂ to C₁₀ polyol and in particular C₂ to C₆ polyol is preferably used as C₂ to C₁₅ polyol component of the alkoxylate. The polyols preferably have from 2 to 8 hydroxyl groups, such as from 2 to 8 and in particular from 2 to 4 hydroxyl groups, such as 2 or 3 hydroxyl groups.

Examples of polyols which can be reacted with a C₂ to C₄ alkylene oxide are ethylene glycol, propylene glycol, diethylene glycol, triethylene glycol, tetraethylene glycol, 1,3-propanediol, glycerol, pentaerythritol, dipentaerythritol, tripentaerythritol, trimethylolethane, trimethylolpropane and mixtures thereof. The polyol of the C₂ to C₄ alkoxylate is preferably selected from the group consisting of ethylene glycol, propylene glycol, diethylene glycol, triethylene glycol, tetraethylene glycol, glycerol and mixtures thereof and is in particular glycerol.

Sugar alcohols such as for example sorbitol, maltitol, mannitol, xylitol and mixtures thereof can also be used as polyols which can be reacted with a C₂ C₄ alkylene oxide. This has the further advantage that the thus-produced rosin esters can be produced more sustainably.

In a further particularly preferred embodiment, the at least one alcohol used is ethoxylated glycerol, which has in particular up to 10, such as 5 to 10, e.g. 7, ethylene oxide units (EO units). Such a glycerol according to the invention is commercially available from Schärer & Schläpfer, for example, as Aduxol-Gly-07.

In a further embodiment, the at least one alcohol used is ethoxylated trimethylolpropane, ethoxylated pentaerythritol or ethoxylated sorbitol.

In an alternative embodiment, the at least one alcohol used (with which the rosin is esterified) comprises or is the product of the reaction of C₂ to C₄ alkylene oxide with at least one monoalcohol, wherein the latter then has at least 2, preferably from at least 2 to 30, in particular from 6 to 12, units derived from C₂ to C₄ alkylene oxide (for short also only: “C₂ to C₄ alkylene oxide units”), preferably ethylene oxide units, propylene oxide units and/or butylene oxide units. The at least one monoalcohol is preferably a hydrocarbon alcohol having a saturated or unsaturated C₈ to C₂₄ hydrocarbon group, in particular C₁₂ to C₁₈ hydrocarbon group. If so-called fatty alcohols from natural sources are used as monoalcohol, they are often present as mixtures.

In an alternative embodiment, the rosin can also be reacted with the product of the reaction of C₂ to C₄ alkylene oxide with at least one carboxylic acid. In this case, the rosin is esterified with the free hydroxyl group resulting from the alkylene oxide reaction. The reaction product preferably has at least 2, preferably from at least 2 to 30, in particular from 6 to 12, units derived from C₂ to C₄ alkylene oxide, in particular ethylene oxide units, propylene oxide units and/or butylene oxide units.

The at least one carboxylic acid is preferably a C₈ to C₂₄ carboxylic acid, in particular C₁₂ to C₁₈ carboxylic acid. If so-called fatty acids from natural sources are used as carboxylic acid, they are often present as mixtures. Examples are castor oil (oleic, linoleic, linolenic and palmitic acids) or coconut oil (oleic, linoleic, linolenic, palmitic, lauric and myristic acids).

The alcohol components used above to prepare the rosin esters according to the invention are generally water-soluble, i.e. at least 1 g dissolves in 100 ml water under standard conditions (standard pressure (approximately 1 bar) and room temperature (approximately 20° C.)).

The rosin ester can be prepared by heating rosin and alcohol together with acid. Hypophosphorous acid or a mixture of hypophosphorous acid and p-toluenesulfonic acid can for example be used as acids.

The molecular weight of the rosin ester is preferably at least 450 g/mol, in particular from 500 to 2000 g/mol. The molecular weight of the rosin ester can be determined by means of gel permeation chromatography using a differential refractometer.

Furthermore, the rosin ester can have a dynamic viscosity at 20° C. of from 2000 to 60000 mPa s, preferably from 2500 to 5000 mPa s and in particular from 3000 to 4500 mPa s.

In a preferred embodiment, the rosin ester according to the invention is liquid under standard conditions (standard pressure (approximately 1 bar) and room temperature (approximately 20° C.)).

### Rubber Additive

The rubber composition according to the invention contains at least one rubber additive which comprises the rosin ester according to the invention as described in detail above. In an embodiment, the rubber additive can consist of the rosin ester. Alternatively, the rubber additive contains at least 50 wt.-%, preferably at least 70 wt.-%, in particular at least 90 wt.-%, rosin ester.

In addition to the rosin ester, the rubber additive can also have still further constituents. In a preferred embodiment, the rubber additive contains fatty acid esters and/or fatty acid soaps, in particular zinc and/or potassium fatty acid soaps.

The rubber additives of the present invention can preferably be present in a blend which contains one or more solid carrier materials and one or more rosin esters. Inorganic fillers (such as for example silicas) or wax-like materials (such as for example polyethylene waxes) can preferably be used as carrier material.

In a preferred variant, a silica is used as carrier material. Examples of commercially available silicas which can be used in the blend of the present invention are Sipernat 22 and Sipernat 50 from Evonik.

The weight ratio of carrier material to rosin ester in the blend is for example from 10/90 to 90/10, more preferably from 20/80 to 80/20 and particularly preferably approximately 30/70 or 33/67.

The use of a blend in particular makes it easier to handle the rosin esters if they are liquid at room temperature.

### Rubber

The rubber composition according to the invention contains at least one rubber.

In a preferred embodiment, the rubber is a rubber that can be crosslinked by means of sulfur crosslinking. According to the invention, rubbers are used which are suitable in particular for the preparation of tread compounds which can be used in the production of tyres.

Preferred rubbers are diene rubbers. Rubbers which are formed by polymerization or copolymerization of dienes and/or cycloalkenes and thus have C═C double bonds either in the main chain or in the side groups are referred to as diene rubbers. Preferred diene rubbers are butadiene rubber, polyisoprene and styrene-butadiene rubber.

In a preferred embodiment, the rubber composition comprises at least one styrene-butadiene rubber, natural rubber, polyisoprene and/or butadiene rubber as well as optionally the functionalized forms thereof.

In a preferred embodiment, the rubber composition contains at least one styrene-butadiene rubber (styrene-butadiene copolymer). This can be both solution-polymerized styrene-butadiene rubber (SSBR) and emulsion-polymerized styrene-butadiene rubber (ESBR), wherein a mixture of at least one SSBR and at least one ESBR can also be used. The terms “styrene-butadiene rubber” and “styrene-butadiene copolymer” are used synonymously in the context of the present invention. The styrene-butadiene copolymer(s) used can be end-group-modified with modifications and functionalizations and/or functionalized along the polymer chains. The modification can be one with hydroxy groups and/or ethoxy groups and/or epoxy groups and/or siloxane groups and/or amino groups and/or aminosiloxane and/or carboxy groups and/or phthalocyanine groups and/or silane sulfide groups. However, further modifications known to a person skilled in the art, also referred to as functionalizations, also come into consideration. Metal atoms can be a constituent of such functionalizations.

According to a preferred embodiment, the rubber composition contains at least one styrene-butadiene rubber, preferably in quantities of from 40 to 100 phr, particularly preferably 70 to 90 phr.

According to a preferred embodiment, the rubber composition contains at least one styrene-butadiene rubber, which is functionalized with at least one of the above-named groups at the polymer chain ends and/or along the polymer chains (“back bone functionalized”). The functional groups are particularly preferably those groups which can bind to silica, such as in particular hydroxy groups and/or ethoxy groups and/or epoxy groups and/or siloxane groups and/or aminosiloxane and/or carboxy groups and/or silane sulfide groups.

The butadiene rubber (═BR, polybutadiene) can be all types known to a person skilled in the art. These include, among other things, the so-called high cis and low cis types, wherein polybutadiene with a cis content greater than or equal to 90 wt.-% is referred to as a high cis type and polybutadiene with a cis content smaller than 90 wt.-% is referred to as a low cis type. A low cis polybutadiene is e.g. Li—BR (lithium-catalyzed butadiene rubber) with a cis content of from 20 to 50 wt.-%.

The polybutadiene used can be end-group-modified and/or functionalized along the polymer chains. Regarding this, reference may be made to the above possibilities disclosed in connection with the modification and functionalization of styrene-butadiene rubber, where appropriate adapted to the requirements of BR as rubber material.

According to a preferred embodiment, the rubber composition contains 5 to 50 phr, preferably 10 to 30 phr, of at least one butadiene rubber.

The rubber composition according to the invention can also contain natural and/or synthetic polyisoprene. Here, both cis-1,4-polyisoprene and 3,4-polyisoprene can be used. The rubber composition preferably contains cis-1,4-polyisoprenes with a cis-1,4 content of more than 90 wt.-%. Natural rubber is a rubber with a high cis-1,4 content. The polyisoprene used can also be end-group-modified and/or functionalized along the polymer chains. Regarding this, reference may be made to the above possibilities disclosed in connection with the modification and functionalization of styrene-butadiene rubber, where appropriate adapted to the requirements of polyisoprene as rubber material.

The named rubbers can also be contained in the rubber composition in combination with one another.

In a preferred embodiment, the rubber composition comprises at least one styrene-butadiene rubber and at least one butadiene rubber, in particular 5 to 40 phr butadiene rubber and 40 to 100 phr styrene-butadiene rubber.

In a preferred embodiment, the rubber composition comprises at least one liquid polymer (viscous liquids at normal temperature) such as for example LIR (liquid polyisoprene), LBR (liquid polybutadiene) and L-SBR (liquid styrene-butadiene).

Kurapren LIR30 and Kurapren LIR50 from Kuraray Co., Ltd. can for example be used as liquid polyisoprene. LBR-302, LBR-307, LBR-305, LBR-352 or LBR-361 from Kuraray Co., Ltd. can for example be used as liquid polybutadiene. L-SBR-820 or L-SBR-841 from Kuraray Co., Ltd. can for example be used as liquid styrene-butadiene.

Furthermore, oil-extended rubber can also be added to the rubber compositions according to the invention. With respect to the quantities of oil-extended rubber used, it is usual to “weigh out” the oil content as well, such that formulations with “rubber” quantities of over 100 phr, such as e.g. up to 200 phr, e.g. in the range 40 or 70 to 140 or 150 phr, can thereby result. As the oil content is usually known, oil-extended rubber can, however, be added such that the sum of the solid rubber components (cf. the above definition under “rubber composition”) is such that a total of 100 parts by weight rubber are present.

The rubber composition according to the invention can additionally contain further rubbers in comparatively small quantities, such as 0.1 to 50 phr.

### Further Additives

The rubber composition of the present invention can contain further additives and constituents, in particular one or more fillers, one or more catalysts or activators for a sulfur crosslinking and optionally further additions such as anti-ageing agents and homogenizers in usual quantities.

In a preferred embodiment, the rubber composition of the present invention contains further additives and constituents which are suitable for the preparation of tread compounds for tyres.

The rubber composition preferably contains at least one filler. The rubber composition can contain 5 to 300 phr, preferably 30 to 300 phr, in particular 50 to 200 phr, of at least one filler, wherein the total quantity of all fillers contained is meant.

According to a preferred embodiment of the invention, the total filler content is 30 to 150 phr, particularly preferably 60 to 140 phr, again preferably 80 to 130 phr, again particularly preferably 100 to 130 phr and again quite particularly preferably 110 to 130 phr.

These can be all fillers known to a person skilled in the art, such as carbon black, carbon nanotubes, silica, aluminosilicates, phyllosilicates such as kaolin, calcium carbonate (chalk), starch, calcium carbonate, barium sulfate, magnesium oxides, aluminium oxides, titanium dioxide, or rubber gels.

The rubber composition preferably contains at least one silica as filler. The silicas can be the silicas known to a person skilled in the art which are suitable as filler for rubber compositions. However, it is particularly preferred if a finely divided, precipitated silica is used which has a nitrogen surface area (BET surface area) (according to DIN ISO 9277) of from 35 to 350 m²/g, preferably from 35 to 260 m²/g, particularly preferably from 100 to 260 m²/g and quite particularly preferably from 115 to 235 m²/g, and a CTAB surface area (according to ASTM D 3765) of from 30 to 400 m²/g, preferably from 30 to 250 m²/g, particularly preferably from 80 to 250 m²/g and quite particularly preferably from 80 to 230 m²/g.

Silicas which can be used are thus e.g. both those of the type Ultrasil® 7000 GR (trade name) from Evonik, as well as Ultrasil® VN3 (trade name) from Evonik, and highly dispersible silicas, so-called HD silicas (e.g. Zeosil® 1165 MP from Solvay).

To improve the processability and to bind the silica and other optionally present polar fillers to the diene rubber, silane coupling agents can be used in rubber compounds. Here, one or more different silane coupling agents can be used in combination with one another. The rubber compound can thus contain a mixture of different silanes. The silane coupling agents react with the silanol groups, on the surface, of the silica or other polar groups during mixing of the rubber or the rubber compound (in situ) or already before the filler is added to the rubber in the sense of a pre-treatment (pre-modification). Silane coupling agents which can be used here are all silane coupling agents known to a person skilled in the art for use in rubber compounds. Such coupling agents known from the state of the art are bifunctional organosilanes, which have at least one alkoxy, cycloalkoxy or phenoxy group as leaving group on the silicon atom and which have, as other functionality, a group which can undergo a chemical reaction with the double bonds of the polymer optionally after cleavage.

It is furthermore advantageous if the rubber composition according to the invention contains at least one plasticizer, wherein the total quantity of plasticizer is preferably 5 to 100 phr. The plasticizers used in the context of the present invention include all plasticizers known to a person skilled in the art such as aromatic, naphthenic or paraffinic mineral oil plasticizers, such as e.g. MES (mild extraction solvate) or RAE (residual aromatic extract) or TDAE (treated distillate aromatic extract), or rubber-to-liquid (RTL) oils or biomass-to-liquid (BTL) oils preferably with a polycyclic aromatic compound content of less than 3 wt.-% according to method IP 346 or factices or plasticizer resins. The rubber composition can contain 5 to 40 phr, preferably 10 to 30 phr, plasticizers.

The rubber composition preferably furthermore contains substances required for the crosslinking such as zinc oxide, accelerators and/or sulfur.

It is in particular advantageous if the rubber composition according to the invention contains zinc oxide or zinc-containing compounds for the activation of the sulfur vulcanization.

The vulcanization of the rubber composition is, where appropriate, carried out in the presence of sulfur and/or sulfur donors and with the aid of vulcanization accelerators, wherein some vulcanization accelerators can at the same time act as sulfur donors, and sulfur and/or sulfur donors as well as vulcanization accelerators are used in the quantities known in the state of the art. Sulfur and/or sulfur donors as well as one or more accelerators are added to the rubber compound in the named quantities in the final mixing step. The accelerator is selected from the group consisting of thiazole accelerators and/or mercapto accelerators and/or sulfenamide accelerators and/or thiocarbamate accelerators and/or thiuram accelerators and/or thiophosphate accelerators and/or thiourea accelerators and/or xanthogenate accelerators and/or guanidine accelerators. The use of at least one sulfenamide accelerator which is selected from the group consisting of N-cyclohexyl-2-benzothiazolesulfenamide (CBS) and/or N,N-dicyclohexylbenzothiazole-2-sulfenamide (DCBS) and/or benzothiazyl-2-sulfenmorpholide (MBS) and/or 2,2′-dibenzothiazyl disulfide (MBTS) and/or N-tert-butyl-2-benzothiazyl sulfenamide (TBBS) is preferred.

Several accelerators can also be used. A sulfenamide accelerator, particularly preferably CBS, is preferably used in combination with the guanidine accelerator DPG (diphenylguanidine). The quantity of DPG is 0 to 5 phr, preferably 0.1 to 3 phr, particularly preferably 0.5 to 2.5 phr, quite particularly preferably 1 to 2.5 phr.

In addition, the rubber composition can contain usual admixtures in usual parts by weight. The admixtures can be selected from the list consisting of anti-ageing agents, activators, waxes, resins, mastication aids and processing aids and mixtures thereof.

N-Phenyl-N′-(1,3-dimethylbutyl)-p-phenylenediamine (6PPD), N,N′-diphenyl-p-phenylenediamine (DPPD), N,N′-ditolyl-p-phenylenediamine (DTPD), N-isopropyl-N′-phenyl-p-phenylenediamine (IPPD) and 2,2,4-trimethyl-1,2-dihydroquinoline (TMQ) can for example be used as anti-ageing agents. The rubber composition according to the invention preferably comprises 0.1 to 3 phr anti-ageing agents.

Zinc oxide and fatty acids (e.g. stearic acid) or zinc complexes such as e.g. zinc ethylhexanoate can for example be used as activators. The rubber composition according to the invention preferably comprises 0.5-10 phr, preferably 2-5 phr, activators.

The rubber composition according to the invention preferably comprises 0.1-3 phr waxes.

Plasticizer resins, such as e.g. C₅ petroleum resin, C₉ petroleum resin, terpene resin, coumarone-indene resin or a hydrocarbon resin consisting of alpha-methylstyrene and styrene (AMS resin), can in particular be used as resins. The rubber composition according to the invention preferably comprises 5 to 100 phr, preferably 15 to 50 phr, resins.

2,2′-Dibenzamidodiphenyl disulfide (DBD) can for example be used as mastication aid. The rubber composition according to the invention preferably comprises 0.1 to 3 phr mastication aids.

Fatty acid salts, such as e.g. zinc soaps, and fatty acid esters and derivatives thereof can for example be used as processing aids. The rubber composition according to the invention preferably comprises 0.5 to 10 phr, preferably 2 to 5 phr, processing aids.

In particular, the rubber composition contains
a) 0.1 to 3 phr anti-ageing agents,
b) 0.5 to 10 phr, preferably 2 to 5 phr, activators,
c) 0.1 to 3 phr waxes,
d) 5 to 100 phr, preferably 15 to 50 phr, resins,
e) 0.1 to 3 phr mastication aids, and
f) 0.5 to 10 phr, preferably 2 to 5 phr, processing aids.

The proportion of further admixtures in the total quantity is 3 to 150 phr, preferably 3 to 100 phr and particularly preferably 5 to 80 phr.

### Composition

The rubber composition preferably contains between 0.1 and 40 phr rosin ester according to the invention, preferably 1 to 30 phr.

In a preferred embodiment, the composition has an at least 5%, preferably 10%, in particular 15%, lower rolling resistance, tan delta at 60° C., and/or a 5%, preferably 10%, in particular 15%, higher wet grip, tan delta at 0° C., after vulcanization.

Furthermore, the composition preferably has an improved processability, in particular an at least 5%, preferably 10%, in particular 15%, lower Mooney viscosity and/or a correspondingly lower Garvey die material pressure.

Furthermore, the composition preferably has an improved stiffness, in particular an at least 5%, preferably 10%, in particular 15%, higher tear strength and/or elongation at break and/or tensile strength, modulus at 100%, and/or tensile strength, modulus at 300%.

The above-named improvements (lower rolling resistance, higher wet grip, improved processability, increased stiffness) can occur in comparison with an identical composition which comprises a rubber additive known from the state of the art in identical quantity instead of the additive according to the invention. Commercially available rubber additives, such as Novares C 10, can be used as known (comparison) rubber additive. For testing, two otherwise identical rubber compositions are prepared and their properties are then compared with each other.

The above-named improvements can also be determined in comparison with an identical composition which does not contain the rubber additive according to the invention. For testing, in this case two identical rubber compositions are prepared and the rubber additive according to the invention is additionally added to one of them. The properties of the two rubber compositions are then compared with each other.

The rubber composition is preferably suitable for the preparation of tread compounds for tyres. The rubber composition according to the invention is furthermore also suitable for treads which consist of different tread compounds arranged next to one another and/or one underneath the other (multicomponent treads).

### Preparation

The preparation of the rubber compound according to the invention is effected in a conventional manner, wherein first of all a basic mixture which contains all constituents with the exception of the vulcanization system (sulfur and vulcanization-influencing substances) is as a rule prepared in one or more mixing steps and the finished mixture is subsequently produced by adding the vulcanization system.

The mixture can then be further processed, e.g. through an extrusion process, and be brought into the corresponding form, e.g. the form of a tread blank.

The general process for preparing rubber compounds and vulcanisates thereof is described in “Rubber Technology Handbook”, W. Hofmann, Hanser Verlag 1994. It is known to a person skilled in the art that, where appropriate depending on the mixture, in particular depending on the filler content, further mixing steps are to be carried out after the first basic mixing step, in order to achieve a better lowering of the viscosity and a better homogenization.

### Tyres

The present invention also relates to tyres in which at least one component part has been produced at least partially from a rubber composition according to the invention. The tyre is preferably an Ultra High Performance (UHP) or summer tyre.

In the context of the present invention, by tyres is meant vehicle pneumatic tyres and solid rubber tyres, including tyres for industrial and construction site vehicles, HGV, car and two-wheel tyres.

According to a preferred embodiment of the invention, the tyre has the rubber composition according to the invention at least in the tread.

The present invention furthermore relates to a process for producing a tyre, wherein one or more component parts of the tyre are produced from the rubber composition according to the invention and the rubber composition is cured.

The use of the rubber composition according to the invention can significantly improve the process for producing tyres and treads.

### Use

The present invention furthermore relates to the use of rosin ester consisting of rosin and at least one alcohol as rubber additive in a rubber composition for improving the Mooney viscosity of the rubber composition and/or for improving at least one of wear, grip and rolling resistance of a tyre produced from the rubber composition, wherein the rosin used has an acid number of from 130 to 190 mg KOH/g and the alcohol(s) used has or have a molecular weight of at least 200 g/mol and not more than seven hydroxyl groups.

In a preferred embodiment, at least one of the named properties is improved by at least 5%, preferably at least 10%, compared with a rubber composition which comprises a known rubber additive in identical quantity instead. Commercially available rubber additives, such as for example Novares C 10, can be used as known (comparison) rubber additive.

The rubber additive according to the invention can be used in particular in a rubber composition for treads.

In a preferred embodiment, in the case of the use according to the invention a blend is used which contains
a) one or more solid carrier materials,
b) one or more rosin esters according to the invention.

Inorganic fillers (such as for example silicas) or wax-like materials (such as for example polyethylene waxes) can preferably be used as carrier material. In a preferred embodiment, a silica is used as carrier material.

The weight ratio of carrier material to rosin ester in the blend is for example from 10/90 to 90/10, more preferably from 20/80 to 80/20 and particularly preferably approximately 30/70 or 33/67.

### EMBODIMENT EXAMPLES

The invention will now be explained in more detail with reference to comparison and embodiment examples, without being limited to these examples, however.

### Example 1—Preparation of the Rubber Additives

a) Esterification of Colophony with Ethoxylated Glycerol (Additive A)

369.0 g ethoxylated glycerol (Aduxol GLY-07 from Schärer+Schläpfer) and 1.4 g hypophosphorous acid were placed under a nitrogen atmosphere and the mixture was heated to 100° C. A total of 473.1 g rosin (Gresinox 578 M from DRT, acid number 160 mg KOH/g) was then added in portions and the mixture was slowly heated to 220° C. and a vacuum was applied. The reaction progress was monitored by measuring the acid number. A liquid which is viscous at room temperature was obtained with a pour point at approx. 0° C., measured according to DIN EN ISO 3016.

b) Esterification of Colophony with Ethoxylated Glycerol (Additive B)

4000 g ethoxylated glycerol (Aduxol GLY-07 from Schärer+Schläpfer), 9.2 g hypophosphorous acid, 4.14 g paratoluenesulfonic acid and 5190 g rosin (Gresinox 578 M from DRT) were combined under a nitrogen atmosphere, the mixture was slowly heated to 245° C. and a vacuum was applied. The reaction progress was monitored by measuring the acid number. A liquid which is viscous at room temperature was obtained with a pour point at 12° C. The density at 20° C. is 1100 kg/m³.

c) Esterification of Colophony with Polyethylene Glycol 400 (Additive C)

In a further approach, 332.23 g rosin (Gresinox 578 M from DRT) and 385.07 g polyethylene glycol 400 (Carbowax PEG 400DE from DOW Chemical Company) were esterified with the aid of zinc oxide as catalyst. The dynamic viscosity of the ester obtained at 20° C. is 3,700 mPa.

### Example 2—Preparation of the Rubber Composition

The mixture was prepared under usual conditions in one or more mixing steps. It is then further processed, e.g. through an extrusion process, and brought into the corresponding form. The various components of the individual mixtures are specified in the tables given below.

TABLE 1

| Component | Chemical class | Properties |
|---|---|---|
| Sprintan SLR 3402 | Styrene-butadiene rubber | Glass transition temperature −62° C. |
| Sprintan 918S | Styrene-butadiene rubber | Glass transition temperature −33° C. |
| Buna CB 24 | Butadiene rubber | Neodymium BR, Mooney viscosity |
| | | 44 MU, cis 1,4 content = 96% |
| Ultrasil 7000 GR | Silica | CTAB surface area = 160 m2/g |
| Zeosil Premium 200 | Silica | CTAB surface area = 200 m2/g |
| MP | | |
| Struktol SCA 985 | Bis(triethoxysilylpropyl) | Silane |
| | disulfide | |
| Luvomaxx BC N-330 | Carbon black | Iodine adsorption number: |
| | | 82 ± 5 [g/kg] |
| Novares C 10 | Coumarone-indene resin | Softening point 10° C. |
| Pinerez 7024 | Resin | Triethylene glycol ester of rosin |
| Struktol EF44 | Mixture of fatty acid | Processing aid |
| | derivatives, principally zinc | |
| | soaps | |
| Tudalen 4192 | Processing oil | Plasticizer |
| Varazon 5998 | Wax | Antiozonant |
| ZnO Harzsiegel GR | Zinc oxide | Activator |
| 6PPD | N-(1,3-dimethylbutyl)-N′- | Anti-ageing agent |
| | phenyl-1,4-benzenediamine | |
| TBBS | N-tert-butyl-2-benzothiazyl | Accelerator |
| | sulfenamide | |
| CBS | N-cyclohexyl-2- | Accelerator |
| | benzothiazolesulfenamide | |
| DPG | 1,3-Diphenylguanidine | Accelerator |

In all of the mixture examples contained in the table, the quantities specified (parts by weight) are based on 100 parts by weight total rubber (phr).

Test pieces were prepared from all mixtures and material properties typical of the rubber industry were ascertained with these test pieces using the test methods specified in the following:
Mooney viscosity (MS 1+4, 100° C.), after each mixing step and after ageing, in each case according to DIN EN ISO 289-1
Extrusion parameters (extrusion speed, die swell, extrusion rate, material pressure, material temperature) surface evaluation (Garvey die: surface A-E with A as best grade, edges 1-10 with 10 as best grade), in each case according to ASTM D 2230.
Rebound resilience at RT, measured according to ASTM D-8059
Shore A hardness at room temperature (RT), measured according to DIN EN ISO 868,
Tear strength, elongation at break and tensile strength measured according to DIN 53 504, parameters for stiffness, also for tyre wear
Stress values at 100 and 300% elongation at room temperature (modulus at 100%, modulus at 300%), according to DIN 53 504
Loss factor tan delta at 0° C. and 60° C. according to DIN 53 545
   dynamic mechanical analysis, wherein the vulcanized material is clamped and dynamically loaded
   wet grip can be correlated with the tan delta at 0° C. (the larger the tan delta at 0° C., the better the wet grip),
   rolling resistance can be correlated with the tan delta at 60° C. (the smaller the tan delta at 60° C., the lower the rolling resistance),
Rebound resilience according to DIN 53512

### Example 3—Comparison with Struktol EF44

The rubber compositions according to the invention were tested compared with additives established in the tyre industry. Here, a rubber composition which contains the additive B prepared in Example 1 b) (ester consisting of rosin acid and ethoxylated glycerol) (composition C) was compared with a rubber composition which contains the commercially available additive Struktol EF44 (mixture of fatty acid derivatives, principally zinc soaps, Schill+Seilacher “Struktol” GmbH) (composition B) and a rubber composition which contains neither of the two additives (composition A).

As can be seen from the table given below, the rubber composition C according to the invention has advantages in the area of tyre handling (=higher stiffness) and tyre grip compared with the comparison composition B, with comparably good processability of the rubber composition and the same tyre wear, with higher rolling resistance.

With these results, the additives according to the invention are suitable specifically for Ultra High Performance (UHP) and summer tyres. At the same time, the other properties stay at the same level and are not significantly impaired or are even partially improved.

TABLE 2

| Composition | A | B | C |
|---|---|---|---|
| Sprintan SLR 3402 | 80.00 | 80.00 | 80.00 |
| Buna CB 24 | 20.00 | 20.00 | 20.00 |
| Ultrasil 7000 GR | 100.00 | 100.00 | 100.00 |
| Struktol SCA 985 | 8.00 | 8.00 | 8.00 |
| Luvomaxx BC N-330 | 8.00 | 8.00 | 8.00 |
| Tudalen 4192 (TDAE oil) | 25.00 | 25.00 | 25.00 |
| ZnO Harzsiegel GR | 2.50 | 2.50 | 2.50 |
| Varazon 5998 | 1.50 | 1.50 | 1.50 |
| Stearic acid | 1.00 | 1.00 | 1.00 |
| Richon 6PPD | 2.00 | 2.00 | 2.00 |
| Sulfur | 1.40 | 1.40 | 1.40 |
| Double Vigour CBS-G | 1.70 | 1.70 | 1.70 |
| Double Vigour DPG-C | 2.00 | 2.00 | 2.00 |
| Struktol EF 44 | | 3.00 | |
| Additive B | | | 3.00 |

Processability

| | | | |
|---|---|---|---|
| 1st mixing step: Mooney MS [1 + 4] | 84 | 70 | 76 |
| 100° C. [MU] | | | |
| Roll behaviour [1 = sticky; 5 = | 2 | 4 | 4 |
| bagging] | | | |
| 2nd mixing step: Mooney MS [1 + 4] | 61 | 52 | 54 |
| 100° C. [MU] | | | |
| Garvey die, 60 rpm/min material | 81 | 67 | 71 |
| pressure [bar] | | | |

Tyre wear, handling

| | | | |
|---|---|---|---|
| 1st mixing step: G′ at 0.98% | 2351 | 906 | 2069 |
| tension [kPa] | | | |
| 2nd mixing step: G′ at 0.98% | 1190 | 416 | 1171 |
| tension [kPa] | | | |
| Shore A hardness at room | 76 | 68 | 76 |
| temperature [Sh · U] | | | |
| Tear strength [MPa] | 19.3 | 20.5 | 20.2 |
| Elongation at break [%] | 306 | 378 | 353 |
| Stress value at 100% [MPa] | 4.3 | 2.9 | 3.8 |
| Stress value at 300% [MPa] | — | 15 | 16.8 |
| E* at 60° C. [MPa] | 12.3 | 7.1 | 12.3 |
| E′ at 60° C. [MPa] | 12.1 | 7.0 | 12.0 |

Tyre grip

| | | | |
|---|---|---|---|
| Rebound resilience [%] | 22 | 26 | 21 |
| tan delta at 20° C. | 0.343 | 0.319 | 0.404 |

Rolling resistance

| | | | |
|---|---|---|---|
| tan delta at 60° C. | 0.182 | 0.168 | 0.234 |

### Example 4—Comparison with TDAE Oil (Standard)

In this example, the properties of a rubber composition which contains the additive B prepared in Example 1 b) (composition D) were compared with the properties of an otherwise identical rubber composition which contains only TDAE oil (composition E). The comparison showed improved processing properties as well as a higher stiffness of the rubber composition D according to the invention, which brings with it better tyre grip properties (lower rebound resilience, higher tan delta at 0° C. and only slightly higher tan delta at 60° C.).

TABLE 3

| Composition | D | E |
|---|---|---|
| Sprintan SLR 3402 | 80 | 80 |
| Buna CB 24 | 20 | 20 |
| Ultrasil 7000 GR | 100 | 100 |
| Struktol SCA 985 | 8 | 8 |
| Luvomaxx BC N-330 | 8 | 8 |
| ZnO Harzsiegel GR | 2.5 | 2.5 |
| Varazon 5998 | 1.5 | 1.5 |
| Stearic acid | 1 | 1 |
| Richon 6PPD | 2 | 2 |
| Sulfur | 1.4 | 1.4 |
| Double Vigour CBS-G | 1.7 | 1.7 |
| Double Vigour DPG-C | 2 | 2 |
| Tudalen 4192 (TDAE oil) | 15 | 20 |
| Additive B | 5 | |

Processability

| | | |
|---|---|---|
| 1st mixing step: Mooney MS [1 + 4] | 91 | 102 |
| 100° C. [MU] | | |
| 2nd mixing step: Mooney MS [1 + 4] | 77 | 86 |
| 100° C. [MU] | | |
| 2 weeks/RT | 84 | 98 |
| Garvey die, 60 rpm/min material pressure [bar] | 92 | 100 |

Tyre wear, handling

| | | |
|---|---|---|
| 1st mixing step: G′ at 0.98% tension [kPa] | 3152 | 2769 |
| 2nd mixing step: G′ at 0.98% tension [kPa] | 1808 | 1857 |
| Tear strength [MPa] | 19 | 20 |
| Elongation at break [%] | 291 | 334 |
| Stress value at 100% [MPa] | 4 | 4 |
| E* at 60° C. [MPa] | 16 | 14 |
| E′ at 60° C. [MPa] | 16 | 13 |

Tyre grip

| | | |
|---|---|---|
| Rebound resilience [%] | 36 | 37 |
| tan delta at 0° C. | 0.392 | 0.359 |
| tan delta at 20° C. | 0.339 | 0.287 |

Rolling resistance

| | | |
|---|---|---|
| tan delta at 60° C. | 0.222 | 0.194 |

### Example 5—Comparison with Short-Chain Rosin Esters

In this example, the properties of a rubber composition which contains the additive B prepared in Example 1 b) (composition F) were compared with the properties of an otherwise identical rubber composition which contains a short-chain rosin ester (Pinerez 7024E (rosin ester consisting of rosin and triethylene glycol), composition G).

The composition F according to the invention exhibited a higher stiffness, a better rolling resistance and better tyre grip, with equally good processability.

TABLE 4

| Composition | F | G |
|---|---|---|
| Sprintan SLR 3402 | 80 | 80 |
| Buna CB 24 | 20 | 20 |
| Ultrasil 7000 GR | 100 | 100 |
| Struktol SCA 985 | 8 | 8 |
| Luvomaxx BC N-330 | 8 | 8 |
| Tudalen 4192 (TDAE oil) | 15 | 15 |
| ZnO Harzsiegel GR | 2.5 | 2.5 |
| Varazon 5998 | 1.5 | 1.5 |
| Stearic acid | 1 | 1 |
| Richon 6PPD | 2 | 2 |
| Sulfur | 1.4 | 1.4 |
| Double Vigour CBS-G | 1.7 | 1.7 |
| Double Vigour DPG-C | 2 | 2 |
| Additive B | 15 | |
| Pinerez 7024 | | 15 |

Processability

| | | |
|---|---|---|
| 1st mixing step: Mooney MS [1 + 4] 100° C. [MU] | 76 | 70 |
| 2nd mixing step: Mooney MS [1 + 4] 100° C. [MU] | 96 | 98 |
| 24 h/RT | 54 | 55 |
| 1 week/RT | 59 | 58 |
| Garvey die, 60 rpm/min material pressure [bar] | 65 | 71 |

Tyre wear, handling

| | | |
|---|---|---|
| Tear strength [MPa] | 21.8 | 23.4 |
| Elongation at break [%] | 414 | 532 |
| Stress value at 100% [MPa] | 3.1 | 2.5 |
| Stress value at 300% [MPa] | 14.4 | 10.5 |
| E* at 60° C. [MPa] | 13.8 | 11.7 |
| E′ at 60° C. [MPa] | 13.5 | 11.3 |

Tyre grip

| | | |
|---|---|---|
| Rebound resilience [%] | 35 | 32 |
| tan delta at 0° C. | 0.493 | 0.45 |
| tan delta at 20° C. | 0.418 | 0.385 |

Rolling resistance

| | | |
|---|---|---|
| tan delta at 60° C. | 0.22 | 0.268 |

### Example 6—Comparison with Tyre Resins

In this example, the properties of a rubber composition which contains the additive A prepared in Example 1 a) (composition H) were compared with the properties of an otherwise identical rubber composition which contains a commercially available tyre resin (Novares C 10, composition I).

The rubber composition H according to the invention exhibited a higher stiffness and thus better tyre grip, as well as an improved processability with at the same time good rolling resistance.

TABLE 5

| Composition | H | I |
|---|---|---|
| Sprintan 918S | 100 | 100 |
| Buna CB 24 | 20 | 20 |
| Zeosil Premium 200 MP | 80 | 80 |
| Struktol SCA 985 | 8 | 8 |
| N-330 Corax | 8 | 8 |
| ZnO Harzsiegel GR | 2.5 | 2.5 |
| Varazon 5998 | 1.5 | 1.5 |
| Stearic acid | 1 | 1 |
| Santoflex 6PPD | 2 | 2 |
| Sulfur | 1.4 | 1.4 |
| Double Vigour TBBS-G | 1.7 | 1.7 |
| Ekaland DPG | 2 | 2 |
| Additive A | 15 | |
| Novares C 10 | | 15 |

Processability

| | | |
|---|---|---|
| 1st mixing step: Mooney MS [1 + 4] 100° C. [MU] | 79 | 94 |
| 2nd mixing step: Mooney MS [1 + 4] 100° C. [MU] | 59.0 | 85 |
| 3rd mixing step: Mooney MS [1 + 4] 100° C. [MU] | 94.0 | 125 |
| 2 weeks/RT | 61 | 85 |

Tyre wear, handling

| | | |
|---|---|---|
| G′ at 0.98% tension (kPa) | 553 | 791 |
| Tear strength [MPa] | 25.3 | 24.5 |
| Elongation at break [%] | 464.0 | 518.0 |
| Stress value at 100% [MPa] | 4 | 2 |
| Stress value at 300% [MPa] | 15.7 | 11.8 |
| E* at 60° C. [MPa] | 8 | 7 |
| E′ at 60° C. [MPa] | 7.7 | 6.4 |

Tyre grip

| | | |
|---|---|---|
| Rebound resilience [%] | 23 | 26 |
| tan delta at 0° C. | 0.682 | 0.616 |
| tan delta at 20° C. | 0.42 | 0.334 |

Rolling resistance

| | | |
|---|---|---|
| tan delta at 60° C. | 0.165 | 0.166 |

### Example 7—Results with Polyethylene Glycol Rosin Ester

In this example, the properties of a rubber composition which contains additive C′ (composition J) or additive D (composition K) as rubber additives according to the invention were compared with the properties of an otherwise identical rubber composition which contains a low-molecular-weight (comparison) additive E (composition L). The additive C′ according to the invention is a PEG 400 rosin ester and the additive D according to the invention is a PEG 600 rosin ester. With respect to the preparation thereof, reference can be made to the possible synthesis methods according to Examples 1a) to 1c). The rosin used for the preparation had an acid number of 158 mg KOH/g. The comparison additive E is a diethylene glycol rosin ester prepared with the same process.

The additives according to the invention exhibited a higher stiffness, an improved rolling resistance, as well as an improved processability.

TABLE 6

| Composition | J | K | L |
|---|---|---|---|
| Sprintan SLR 3402 | 80 | 80 | 80 |
| Buna CB 24 | 20 | 20 | 20 |
| Ultrasil 7000 GR | 100 | 100 | 100 |
| Struktol SCA 985 | 8 | 8 | 8 |
| Luvomaxx BC N-330 | 8 | 8 | 8 |
| Tudalen 4192 (TDAE oil) | 15 | 15 | 15 |
| ZnO Harzsiegel GR | 2.5 | 2.5 | 2.5 |
| Varazon 5998 | 1.5 | 1.5 | 1.5 |
| Stearic acid | 1 | 1 | 1 |
| Richon 6PPD | 2 | 2 | 2 |
| Sulfur | 1.4 | 1.4 | 1.4 |
| Double Vigour CBS-G | 1.7 | 1.7 | 1.7 |
| Double Vigour DPG-C | 2 | 2 | 2 |
| Additive C′ | 15 | | |
| Additive D | | 15 | |
| Comparison additive E | | | 15 |

Processability

| | | | |
|---|---|---|---|
| 1st mixing step: Mooney MS [1 + | 85 | 75 | 75 |
| 4] 100° C. [MU] | | | |
| 2nd mixing step: Mooney MS [1 + | 104 | 101 | 105 |
| 4] 100° C. [MU] | | | |
| 24 h/RT | 59 | 57 | 59 |
| 1 week/RT | 61 | 62 | 65 |
| Garvey die, 60 rpm/min material | 60 | 57 | 57 |
| pressure [bar] | | | |
| Edge/surface evaluation | 9A | 9A | 6A |

Tyre wear, handling

| | | | |
|---|---|---|---|
| G′ at 0.98% tension [kPa] | 1628 | 1414 | 954 |
| Tear strength [MPa] | 21 | 21.3 | 22.6 |
| Elongation at break [%] | 399 | 421 | 482 |
| Stress value at 100% [MPa] | 3.2 | 3.2 | 2.6 |
| Stress value at 300% [MPa] | 14.6 | 14.1 | 11.9 |
| E* at 60° C. [MPa] | 15 | 12.7 | 13.8 |
| E′ at 60° C. [MPa] | 14.8 | 12.5 | 13.3 |

Tyre grip

| | | | |
|---|---|---|---|
| Rebound resilience [%] | 38 | 39 | 31? |
| tan delta at 0° C. | 0.447 | 0.442 | 0.44 |

Rolling resistance

| | | | |
|---|---|---|---|
| tan delta at 60° C. | 0.173 | 0.167 | 0.272 |

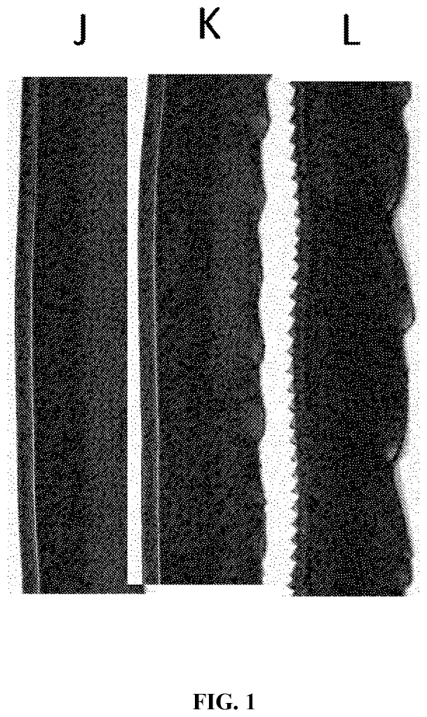

A depiction of the three different extrudates of the compositions J. K and L is represented in FIG. 1. As depicted, the rubber compositions according to the invention have fewer edges.

1. A rubber composition which contains rubber and at least one rubber additive, characterized in that the at least one rubber additive comprises rosin ester from rosin and at least one alcohol, wherein the rosin used to prepare the rosin ester has an acid number of from 130 to 190 mg KOH/g and the alcohol(s) used has or have not more than seven hydroxyl groups and a molecular weight of at least 200 g/mol.

2. The rubber composition according to claim 1, characterized in that the at least one alcohol used to prepare the rosin ester has a molecular weight of at least 380, preferably from 380 to 2000 g/mol.

3. The rubber composition according to claim 1, characterized in that the at least one alcohol used to prepare the rosin ester has at least 2 hydroxyl groups, and in particular 2, 3 or 4 hydroxyl groups.

4. The rubber composition according to claim 1, characterized in that the at least one alcohol used to prepare the rosin ester is selected from the group consisting of C₂ to C₄ alkoxylate of a polyol, polyethylene glycol, polypropylene glycol and/or copolymer of ethylene oxide and propylene oxide.

5. The rubber composition according to claim 1, characterized in that the at least one alcohol used to prepare the rosin ester is selected from the group consisting of polyethylene glycol (PEG), such as PEG having a molecular weight of from 200 to 800 g/mol, polypropylene glycol (PPG), such as PPG having a molecular weight of from 200 to 800 g/mol and ethoxylated glycerol that has in particular up to 10, such as 5 to 10, e.g. 7, ethylene oxide units (EO units).

6. The rubber composition according to claim 1, wherein the rosin used to prepare the rosin ester has an acid number of from 140 to 180 mg KOH/g.

7. The rubber composition according to claim 1, characterized in that the composition contains between 0.1 and 40 phr rosin ester, preferably 1 to 30 phr.

8. The rubber composition according to claim 1, characterized in that it comprises at least one styrene-butadiene rubber, polyisoprene rubber, natural rubber and/or butadiene rubber as well as optionally the functionalized forms thereof.

9. The rubber composition according to claim 1, characterized in that the rosin used to prepare the rosin ester is a disproportionated rosin.

10. The rubber composition according to claim 1, characterized in that the composition has an at least 5%, preferably 10%, lower rolling resistance, tan delta at 60° C., and/or a 5%, preferably 10%, higher wet grip, tan delta at 0° C., after vulcanization in comparison with an identical composition which comprises a known rubber additive in identical quantity instead.

11. The rubber composition according to claim 1, characterized in that the composition is suitable for the preparation of tread compounds for tyres.

12. The rubber composition according to claim 1, characterized in that the composition contains further additives and constituents which are suitable for the preparation of tread compounds for tyres, in particular one or more fillers and optionally further additions.

13. A method of using rosin ester from rosin and at least one alcohol as rubber additive in a rubber composition for improving the Mooney viscosity of the rubber composition and/or for improving at least one of wear, grip and rolling resistance of a tyre produced from the rubber composition, wherein the rosin used has an acid number of from 130 to 190 mg KOH/g and the alcohol(s) used has or have a molecular weight of at least 200 g/mol and not more than seven hydroxyl groups.

14. The method of claim 13, wherein at least one of the named properties is improved by at least 5%, preferably at least 10%, compared with a rubber composition which comprises a known rubber additive in identical quantity instead.

15. The method of claim 13, characterized in that the rosin ester is as defined in claim 1.

16. The method of claim 13, characterized in that a blend is used which contains
a) one or more solid carrier material(s), wherein a silica is preferably used as carrier material,
b) one or more of the rosin esters.

17. A process for producing a tyre, characterized in that one or more component parts of the tyre are produced from a rubber composition according to claim 1 and the rubber composition is cured.

18. A tyre in which at least one component part has been produced at least partially from a rubber composition according to claim 1.

19. The tyre of claim 18, wherein the tyre is an Ultra High Performance (UHP) or summer tyre.

20. The tyre of claim 18, wherein the component part is a tyre tread.
